(19) United States
(12) Patent Application Publication
(10) Pub. No.: US 2013/0050098 A1
(43) Pub. Date: Feb. 28, 2013

(54) USER INPUT OF DIACRITICAL CHARACTERS

(71) Applicant: Masahiko Ide, Lempaala (FI)

(72) Inventor: Masahiko Ide, Lempaala (FI)

(73) Assignee: NOKIA CORPORATION, Espoo (FI)

(21) Appl. No.: 13/222,649

(22) Filed: Aug. 31, 2011

(51) Int. Cl. G06F 3/041

(52) U.S. Cl. 345/173

(57) ABSTRACT

A communications terminal 100 is configured to convert user touch-inputs received through a touch-sensitive display 102 into alphabet characters and diacriticized characters, where appropriate, through an intuitive user interface. The terminal 100 includes a means for causing display on a user interface of a keyboard comprising a plurality of individually-selectable keys, each displaying a different alphabet character. In response to receiving user selection of a first alphabet character, the terminal 100 is configured to modify a subset of the keys to display the original alphabet character and a respective one of a set of different diacritical marks appropriate to the selected first alphabet character. In response to user selection of one of the dual-character, modified, keys, either a new alphabet character or a modified version of the first alphabet character having the diacritical mark shown on the selected modified key, is entered into a text editor.

### FIELD OF THE INVENTION

The present invention relates to an apparatus and method for user input of diacritical characters.

### BACKGROUND TO THE INVENTION

Diacritical characters are ancillary glyphs added to basic alphabet characters to modify their sound value. Examples include the tonal and non-tonal characters used in Vietnamese, such as â, \check{a}, ê, ô, o′ and d̅. French is another language in which the use of diacritical marks is well known.

### SUMMARY OF THE INVENTION

A first aspect of the invention provides apparatus comprising:
means for causing display on a user interface of a first keyboard comprising individually-selectable regions each displaying a different alphabet character;
means for receiving user-selection of a first alphabet character for entry into a text string through a region of the keyboard;
means responsive to received selection of the first alphabet character to cause display of a second keyboard including a plurality of dual-character regions each including a different alphabet character and a different diacritical character appropriate to the selected first alphabet character; and
means responsive to subsequent user selection of one of the dual-character regions, said means being configured, dependent on one or more attributes of the subsequent user selection, to perform one of (i) replacing the first alphabet character in the text string with a diacriticized version of said character determined by the selected dual-character region, and (ii) entering into the text string of a further, second alphabetic character, being that shown on the selected dual-character region.

The means responsive to subsequent user selection may be configured to perform one of (i) and (ii) dependent on attributes of a single user input made in relation to the dual-character region.

The means responsive to subsequent user selection may be configured to perform one of (i) and (ii) dependent on the duration of the single user input made in relation to the dual-character region.

The means responsive to subsequent user selection may be configured to perform one of (i) and (ii) dependent on detecting a respective input gesture made to the dual-character region.

The means responsive to received selection of the first alphabet character may be further configured to cause display of the dual-character regions of the second keyboard such that the alphabet characters are shown miniaturized compared with those in the first keyboard. The means responsive to received selection of the first alphabet character may be further configured to cause display of the alphabet character such that it is smaller than the diacritical character displayed in the same region.

The apparatus may further comprise a touch-sensitive display and the first and subsequent user selections may be receivable through the touch-sensitive display.

The apparatus may further comprise text editing means into which either the first character or the modified first character may be entered following subsequent selection.

The apparatus may further comprise means configured to cause re-display of the first keyboard, following the subsequent selection.

The first and second keyboards may comprise substantially identical selectable-region layouts.

The dual-character regions may be configured such that the alphabetic character may be displayed with a predetermined diacritical character in accordance with the Vietnamese telex standard/protocol.

The apparatus may be a mobile communications terminal.

A second aspect of the invention provides apparatus comprising:
means for causing display on a user interface of a keyboard comprising a plurality of individually-selectable keys each displaying a different alphabet character;
means for receiving user selection of a first alphabet character;
means responsive to said user selection to modify a subset of the keys such that each one of said modified keys is shown with its original alphabet character and a respective one of a set of different diacritical marks appropriate to the selected first alphabet character; and
means for receiving user selection through one of the modified keys of one of a further alphabet character or a modified version of the first alphabet character having the diacritical mark shown on the selected modified key.

A third aspect of the invention provides a method comprising:
displaying on a user interface a first keyboard comprising individually-selectable regions each displaying a different alphabet character;
receiving user-selection of a first alphabet character for entry into a text string through a region of the keyboard;
in response to selection of the first alphabet character, causing display of a second keyboard including a plurality of dual-character regions each including a different alphabet character and a different diacritical character appropriate to the selected first alphabet character;
receiving a subsequent user selection of one of the dual-character regions; and dependent on one or more attributes of the subsequent user selection, performing one of (i) replacing the first alphabet character in the text string with a diacriticized version of said character determined by the selected dual-character region, and (ii) entering into the text string of a further, second alphabetic character, being that shown on the selected dual-character region.

The method may comprise performing one of (i) and (ii) dependent on attributes of a single user input made in relation to the dual-character region.

The method may comprise performing one of (i) and (ii) dependent on the duration of the single user input made in relation to the dual-character region.

The method may comprise performing one of (i) and (ii) dependent on detecting a respective input gesture made to the dual-character region.

The method may comprise displaying of the dual-character regions of the second keyboard such that the alphabet characters are shown miniaturized compared with those in the first keyboard. The dual-character regions of the second keyboard may be displayed with the alphabet character smaller than the diacritical character displayed in the same region.

The user selections may be received through a touch-sensitive display.

The method may comprise entering the first alphabet character and/or the second alphabet character into a text editing application.

The method may comprise re-displaying the first keyboard, following the subsequent selection

Displaying the first and second keyboards may comprise displaying substantially identical selectable-region or key top layouts.

Causing display of a second keyboard may further comprise displaying each dual-character region such that the alphabetic character is displayed with a predetermined diacritical character in accordance with the Vietnamese telex standard/protocol.

The method may be performed on a communications terminal.

A fourth aspect of the invention provides a method comprising:
displaying on a user interface a keyboard comprising a plurality of individually-selectable keys each displaying a different alphabet character;
receiving user selection of a first alphabet character;
in response to said user selection, modifying a subset of the keys such that each one of said modified keys is shown with its original alphabet character and a respective one of a set of different diacritical characters appropriate to the selected first alphabet character; and
receiving user selection through one of the modified keys of either the selected alphabet character or a modified version of the first alphabet character having the diacritical mark shown on the selected modified key.

A fifth aspect of the invention provides a computer program comprising instructions that when executed by computer apparatus control it to perform a method above.

A sixth aspect of the invention provides a non-transitory computer-readable storage medium having stored thereon computer-readable code, which, when executed by computing apparatus, causes the computing apparatus to perform a method comprising:
displaying on a user interface a first keyboard comprising individually-selectable regions each displaying a different alphabet character;
receiving user-selection of a first alphabet character for entry into a text string through a region of the keyboard;
in response to selection of the first alphabet character, causing display of a second keyboard including a plurality of dual-character regions each including a different alphabet character and a different diacritical character appropriate to the selected first alphabet character;
receiving a subsequent user selection of one of the dual-character regions; and dependent on one or more attributes of the subsequent user selection, performing one of (i) replacing the first alphabet character in the text string with a diacriticized version of said character determined by the selected dual-character region, and (ii) entering into the text string of a further, second alphabetic character, being that shown on the selected dual-character region.

A seventh aspect of the invention provides apparatus, the apparatus having at least one processor and at least one memory having computer-readable code stored thereon which when executed controls the at least one processor:
to cause display on a user interface of a first keyboard comprising individually-selectable regions each displaying a different alphabet character;
to receive user-selection of a first alphabet character for entry into a text string through a region of the keyboard;
in response to received selection of the first alphabet character to cause display of a second keyboard including a plurality of dual-character regions each including a different alphabet character and a different diacritical character appropriate to the selected first alphabet character; and
in response to subsequent user selection of one of the dual-character regions, and dependent on one or more attributes of the subsequent user selection, to perform one of (i) replacing the first alphabet character in the text string with a diacriticized version of said character determined by the selected dual-character region, and (ii) entering into the text string of a further, second alphabetic character, being that shown on the selected dual-character region.

An eighth aspect of the invention provides apparatus, the apparatus having at least one processor and at least one memory having computer-readable code stored thereon which when executed controls the at least one processor:
to cause display on a user interface of a keyboard comprising a plurality of individually-selectable keys each displaying a different alphabet character;
to receive user selection of a first alphabet character;
to respond to said user selection to modify a subset of the keys such that each one of said modified keys is shown with its original alphabet character and a respective one of a set of different diacritical marks appropriate to the selected first alphabet character; and
to receive user selection through one of the modified keys of one of a further alphabet character or a modified version of the first alphabet character having the diacritical mark shown on the selected modified key.

A ninth aspect of the invention provides a non-transitory computer-readable storage medium having stored thereon computer-readable code, which, when executed by computing apparatus, causes the computing apparatus to perform a method comprising:
displaying on a user interface a keyboard comprising a plurality of individually-selectable keys each displaying a different alphabet character;
receiving user selection of a first alphabet character;
in response to said user selection, modifying a subset of the keys such that each one of said modified keys is shown with its original alphabet character and a respective one of a set of different diacritical characters appropriate to the selected first alphabet character; and
receiving user selection through one of the modified keys of either the selected alphabet character or a modified version of the first alphabet character having the diacritical mark shown on the selected modified key.

### BRIEF DESCRIPTION OF THE DRAWINGS

Embodiments of the invention will now be described, by way of example only, with reference to the accompanying drawings, in which:

FIGS. 1a, b and c are tabular views of the prior art Telex input method for the Vietnamese language, and also show correspondence between sequences and characters according to embodiments of the invention;

FIG. 2 is a screen shot of a graphical user interface (GUI) for entering Vietnamese characters;

FIG. 3 is a perspective view of a mobile terminal embodying aspects of embodiments of the invention;

FIG. 4 is a schematic diagram illustrating components of the FIG. 3 mobile terminal and their interconnection;

FIG. 5 is a flow diagram indicating processing steps performed by the text entry application in a first embodiment;

FIGS. 6a-6d are schematic views of a GUI associated with the text entry application of the first embodiment, at various stages of operation;

FIGS. 7a-7d are schematic views of a GUI associated with the text entry application of the first embodiment, showing entry of an alternative text string; and

FIGS. 8a-8c are schematic views of a GUI associated with the text entry application of the first embodiment, showing how certain inputs can be used to cancel a previously-made operation.

### DETAILED DESCRIPTION OF PREFERRED EMBODIMENTS

A known input method editor (IME) standard for inputting Vietnamese is the Telex standard/protocol. Telex is employed on PCs and other devices using QWERTY keyboards, including mobile devices and data tablets providing touch-sensitive keyboards. Telex works by converting the ASCII code for a letter into the appropriate diacritic or a related function, e.g. cancelling the previous diacritic. The user is required to type in a base letter followed by one or more characters that are converted into the diacritical marks.

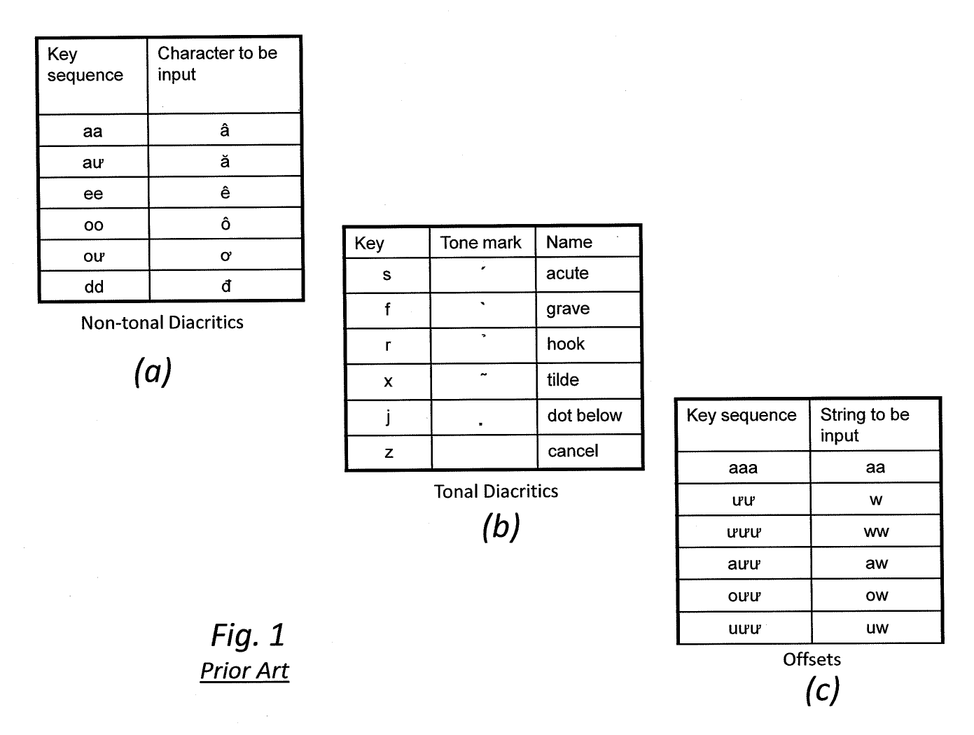

FIGS. 1a, 1b and 1c indicate how input of the various Vietnamese diacritics are entered using the Telex standard. So, for example, input of the character sequence ‘man’ will produce the word ‘cân’. If more than one tone marking key is pressed, the last one will be used. For example, typing “asz” will return “a”. To write a tone marking key as a normal character, one has to press it twice: “herr” becomes “her” and “caaan” becomes “caan”. Further details can be obtained from http://en.wikipedia.org/wiki/Telex (IME).

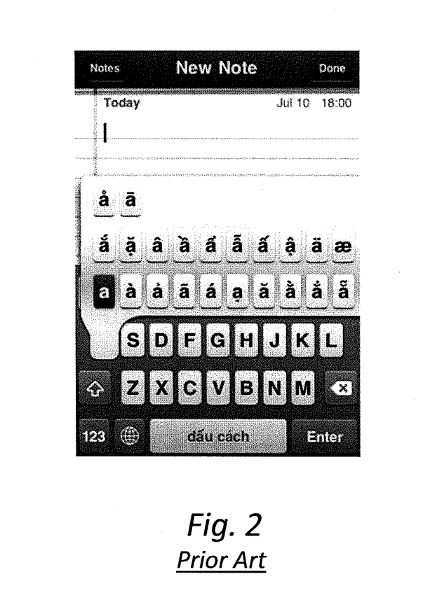

FIG. 2 indicates a different method using a dedicated user interface provided on a touch-screen electronic terminal. In response to prolonged selection (a ‘long press’) of a ‘base’ alphabet letter on a first keyboard, a further keyboard is presented giving selectable, modified versions of the base letter with diacritics. Subsequent selection causes input of the selected modified letter into a text editor.

In the context of this description, the term “alphabet” is intended to include any standardized set of characters, regardless of language, and the term “diacritic” is intended to include any ancillary glyph or marking that can be applied to a letter to modify its tone.

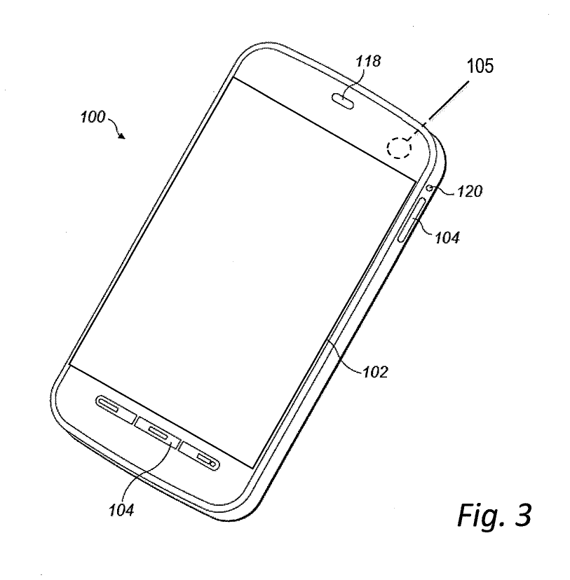

Referring firstly to FIG. 3, a terminal 100 is shown. The exterior of the terminal 100 has a touch sensitive display 102, hardware keys 104, a rear-facing camera 105, a speaker 118 and a headphone port 120. Not all of these features are necessarily present, and in alternative examples different combinations of features may be present. For example, in place of touch screen 102, a non-touch display may be used in conjunction with a separate input device (e.g. a mouse, trackball, and/or physical buttons).

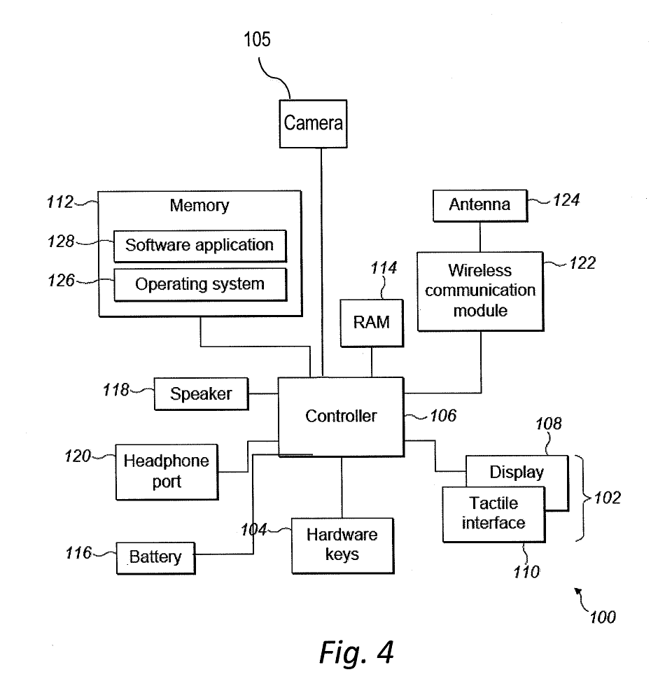

FIG. 4 shows a schematic diagram of the components of terminal 100. The terminal 100 has a controller 106, a touch sensitive display 102 comprised of a display part 108 and a tactile interface part 110, the hardware keys 104, the camera 105, a memory 112, RAM 114, a speaker 118, the headphone port 120, a wireless communication module 122, an antenna 124 and a battery 116. The controller 106 is connected to each of the other components (except the battery 116) in order to control operation thereof. Again, not all of these components are necessarily present.

The memory 112 may be a non-volatile memory such as read only memory (ROM) a hard disk drive (HDD) or a solid state drive (SSD). The memory 112 stores, amongst other things, an operating system 126 and may store software applications 128. The RAM 114 is used by the controller 106 for the temporary storage of data. The operating system 126 may contain code which, when executed by the controller 106 in conjunction with RAM 114, controls operation of each of the hardware components of the terminal.

The controller 106 may take any suitable form. For instance, it may be a microcontroller, plural microcontrollers, a processor, or plural processors.

The terminal 100 may be a mobile telephone or smartphone, a personal digital assistant (PDA), a portable media player (PMP), a portable computer or any other device capable of running software applications and providing audio outputs. In some embodiments, the terminal 100 may engage in cellular communications using the wireless communications module 122 and the antenna 124. The wireless communications module 122 may be configured to communicate via several protocols such as GSM, CDMA, UMTS, Bluetooth and IEEE 802.11 (Wi-Fi).

The display part 108 of the touch sensitive display 102 is for displaying images and text to users of the terminal and the tactile interface part 110 is for receiving touch inputs from users.

As well as storing the operating system 126 and software applications 128, the memory 112 may also store multimedia files such as music and video files. A wide variety of software applications 128 may be installed on the terminal including web browsers, radio and music players, games and utility applications. Some or all of the software applications stored on the terminal may provide audio outputs. The audio provided by the applications may be converted into sound by the speaker(s) 118 of the terminal or, if headphones or speakers have been connected to the headphone port 120, by the headphones or speakers connected to the headphone port 120.

In some embodiments the terminal 100 may also be associated with external software application not stored on the terminal. These may be applications stored on a remote server device and may run partly or exclusively on the remote server device. These applications can be termed cloud-hosted applications. The terminal 100 may be in communication with the remote server device in order to utilize the software application stored there. This may include receiving audio outputs provided by the external software application.

In some embodiments, the hardware keys 104 are dedicated volume control keys or switches. The hardware keys may for example comprise two adjacent keys, a single rocker switch or a rotary dial. In some embodiments, the hardware keys 104 are located on the side of the terminal 100.

The software application 128 includes in this example a program configured to provide an input method editor (IME) and user interface (UI) for user-entry of Vietnamese text to other applications on the Terminal 100. In other examples, an IME and UI may be provided for user-entry of other text to applications on the terminal 100. This is achieved primarily through touch inputs and gestures made through the touch screen 102. The ‘other applications’ may include, for example, a notes application, email application, word processing application or other application requiring textual input, including a web browser. The software application 128 may be provided as an add-on option to the operating system 126, and initiated through a settings menu so as to be applicable to all applications requiring textual input, or as a proprietary application that can be separately downloaded and run as a stand-alone program entity.

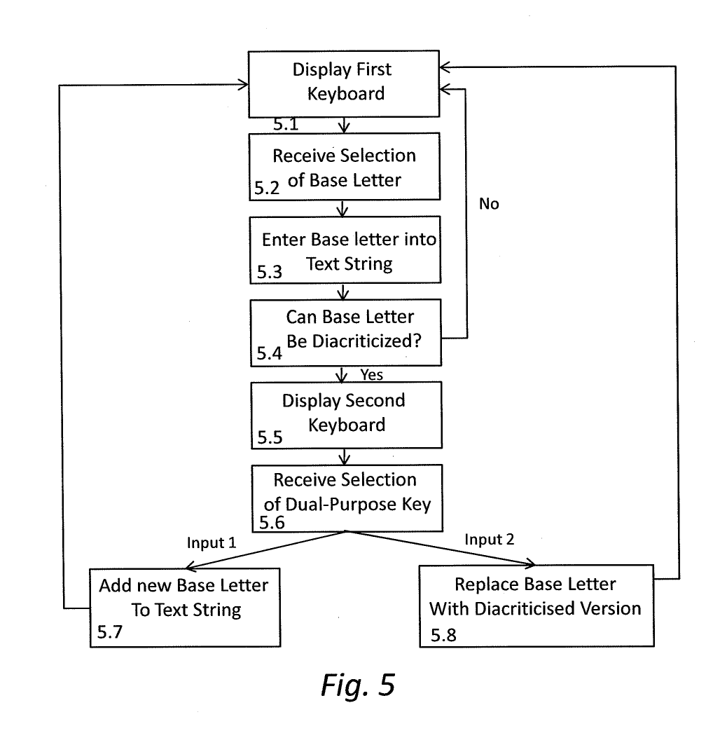

Referring to FIG. 5, an overview of the operating steps performed by the software application 128, when run, is shown. In a first step 5.1, the application 128 displays a first keyboard which may comprise a graphical representation of a keyboard having individual, selectable key top regions, each bearing a different alphabet character or ‘base letter’. In a second step 5.2, user selection of one of the base letters is received, said base letter being entered into a text string in step 5.3, for example in a text editor application.

In step 5.4, the software application 128 determines whether the base letter is one which can be diacriticized, that is modified by a diacritic character or mark. This determination is made using a set of predefined rules based on the relevant language, in this case Vietnamese. Referring back to FIGS. 1a and 1b, for example, in this example if the base letter is a, e, o, or d, then it can be modified with tonal or non-tonal diacritics. The lists are not necessarily exhaustive, for instance u and y are omitted. If the letter selected in step 5.2 cannot be diacriticized, then the first keyboard remains displayed and the method returns to step 5.1. If, however, the selected letter can be diacriticized, then a second keyboard is displayed in step 5.2.

In step 5.2, the second keyboard is preferably shown in place of the first keyboard, and is identical to the first keyboard in terms of its screen position and layout or wireframe. The second keyboard may be a modified version of the first keyboard, and may be termed a “modified keyboard”. At least one he difference between the two keyboards lies in the characters displayed on certain individual keys; in some embodiments this may be the only difference. In particular, a subset of the alphabet keys are replaced with dual-character keys comprising the original alphabet letter from the first keyboard and a respective diacritic character appropriate to the first selected base letter. The letter-to-diacritic pairings may follow the Telex standard mentioned previously. So, if the first selected letter is ‘a’, then seven possible diacritics exist (two non-tonal and five tonal—see FIGS. 1a and 1b) with the circumflex ‘̂’ appearing with the letter ‘a’, the acute accent ‘′’ appearing with letter ‘s’, and so on as per the Telex standard. Where suitable, other standards may be followed.

In step 5.6, if selection of a dual-character key is made, then a determination is made as to whether the alphabet letter or the diacritic character is to be applied. This determination can be based on various attributes of the input made to the touch-sensitive display 102, including duration of a touch input, the number of touch inputs, different types of gestural inputs and so on. In the present example, it is the duration of touch inputs that determines which character is applied. In step 5.7, a prolonged touch input (input 1) of greater than, say, one second causes the relevant alphabet character to be entered after the first selected letter. Alternatively, in step 5.8, a shorter touch input of less than one second causes the relevant diacritic character to be applied to the first selected base letter. More particularly, the first selected base letter is replaced with a diacriticized version of itself, but the term ‘modified’ is used to clarify that the first selected base letter is changed rather than adding a new letter to the text string.

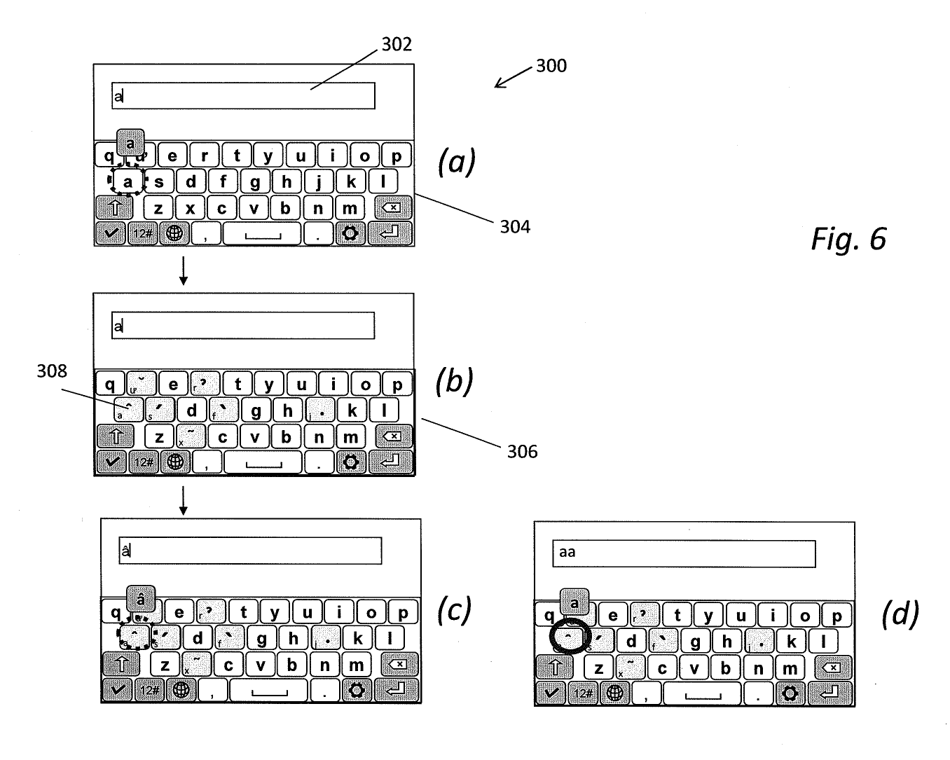

Referring to FIG. 6, the above described procedure will be better understood with reference to some graphical examples. FIG. 6a shows a UI 300 comprising a text string panel 302 and a first keyboard 304. The first keyboard 304 displays a QWERTY keyboard made up of base alphabet letters, as well as the usual function keys. User selection of a first alphabet key ‘a’ is shown in the Figure, as indicated by the dotted circle, which causes the letter ‘a’ to be entered in the text string panel 302. Referring to FIG. 6b, because the letter ‘a’ can be diacriticized, a second (modified) keyboard 306 is displayed in place of the first 304. The change from the first keyboard 304 to the second keyboard 306 may be dynamic in the sense that it is caused to occur automatically without further user input. The second keyboard 306 comprises a subset of dual-character keys, one of which is indicated by reference numeral 308, comprising both the original alphabet character and a respective one of the seven appropriate diacritics. In this example, the dual-function pairings follow the Telex standard.

It is preferred that the diacritic characters are displayed more prominently than the alphabet characters, for example by miniaturizing the alphabet characters. The dual-character keys can alternatively or additionally be shown in a different color.

Referring to FIG. 6c, a short touch selection of letter ‘a’ is operable to cause a circumflexed version of the first entered letter (‘â’) to replace the base letter ‘a’ in the text string panel 302. Referring to FIG. 6d, in the alternative, a prolonged touch selection of letter ‘a’ is operable to enter a second instance of the base letter ‘a’, resulting in ‘aa’ in the text string panel 302. Thus, only a single user input is required to choose either the diacritic modification or the base alphabet letter. In other examples, alternative user inputs may be used to differentiate between the second instance of the base letter and the selection of the diacritical version of the first entered letter, for example swipe movements in alternative directions, or touches of different pressures.

User selections made through the touch-sensitive display 102 in relation to the UI are operable to cause a character bubble, or an enlarged version of the selected letter or diacritical modification, to be displayed prominently as a simulated key top. This display is preferably above the position of the relevant key so that the user's finger will not obscure it, as shown in FIGS. 6a, 6c and 6d.

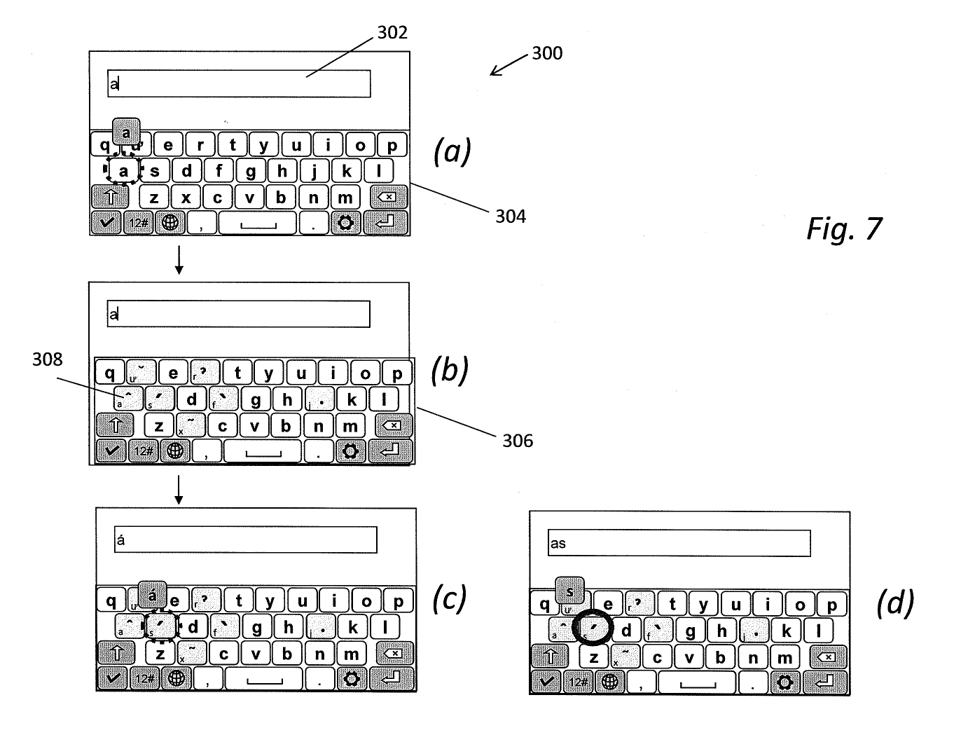

Referring to FIG. 7, a further example is shown which follows the same general process as that described with reference to FIG. 6. FIGS. 7a and 7b are identical to FIGS. 6a and 6b. Referring to FIG. 7c, a short touch selection of the letter ‘s’ is operable to cause an acute accented version of the letter ‘á’ to replace the base letter ‘a’ in the text string panel 302. Referring to FIG. 7d, in the alternative, a prolonged touch selection of letter ‘s’ is operable to enter a second base letter ‘s’ after the initial base letter ‘a’, resulting in ‘as’ in the text string panel 302.

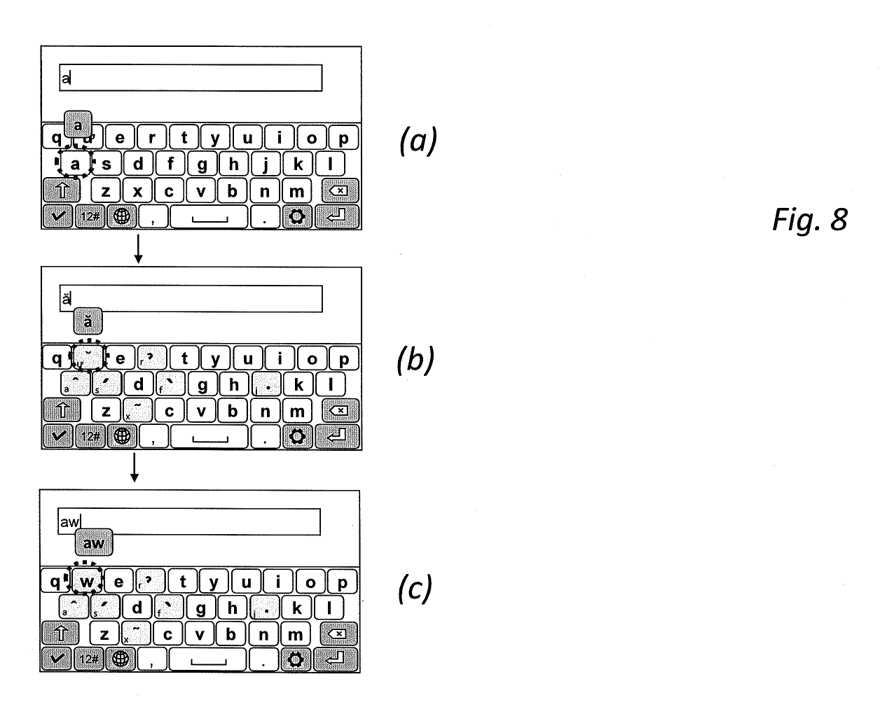

Referring to FIG. 8, as a further feature of the software application 128, in order to input certain character sequences efficiently whilst avoiding inputting a diacritic character to the text string panel 302, a double-touch or double-tap input, is operable to cancel a previous diacritic modification. The key top character changes accordingly and if an alphabet character is shown on the key, the small original character is not shown.

The input of diacritics into a prior art text editor of a prior art electronic apparatus can be cumbersome and require the user to install and have understanding of a particular IME. IMEs commonly require the user to memorize the particular method, use a multitude of keystrokes or touch-inputs to input a single diacritic or remove an automatically-entered diacritic, and/or are not particularly intuitive or convenient.

Compared to the prior art method described with reference to FIG. 2, embodiments of this invention allow quicker text entry in many circumstances. This occurs because in the FIG. 2 prior art the user needs to tap and hold the key to have the characters list and then look for the target character in the list, which slows down typing. This disadvantage is not present in the embodiments described above.

Using a device according to the above described embodiments, a user can enter Vietnamese text similarly to the manner in which they would with a desktop or laptop computer using the Telex method. However, unlike the desktop or laptop computer scenarios, in the embodiments the displayed keyboard (which might be termed keytop printings) change so that the user is guided to type correct keys to enter diacriticized characters, or to avoid diacritics as appropriate.

Although the above example uses the Vietnamese telex method, it will be appreciated that the same principle of operation can be employed with different languages, alphabets and diacritic characters.

It will be appreciated that the above described embodiments are purely illustrative and are limiting on the scope of the invention. Other variations and modifications will be apparent to persons skilled in the art upon reading the present application.

For instance, although the current trend is for touch screen keyboards, in other embodiments the invention is implemented in other virtual keyboards, for example those that are operated on a non-touch screen using e.g. a mouse pointer. Here, user inputs may take the form of operation of hardware keys (left, right keys etc., touch-sensitive pads etc.) and/or mouse-over inputs.

Additionally, other embodiments of the invention include physical keyboards in which at least some keys has their own (tiny) display so that the layout of characters can be dynamically altered. Such physical keyboards may then find utility with desktop and laptop computers as well as with mobile phones, tablet computers etc. In these embodiments, the invention may be implemented by the keyboard alone or by a combination of the keyboard and software running on a connected device such as a desktop computer.

Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

1. (canceled)

2. Apparatus according to claim 29, wherein the computer-readable code when executed controls the at least one processor to respond to subsequent user selection by performing one of (i) and (ii) dependent on attributes of a single user input made in relation to the dual-character region.

3. Apparatus according to claim 2, wherein the computer-readable code when executed controls the at least one processor to respond to subsequent user selection by performing one of (i) and (ii) dependent on the duration of the single user input made in relation to the dual-character region.

4. Apparatus according to claim 29, wherein the computer-readable code when executed controls the at least one processor to respond to subsequent user selection is by performing one of (i) and (ii) dependent on detecting a respective input gesture made to the dual-character region.

5. Apparatus according to claim 29, wherein the computer-readable code when executed controls the at least one processor to respond to received selection of the first alphabet character by causing display of the dual-character regions of the second keyboard such that the alphabet characters are shown miniaturized compared with those in the first keyboard.

6. Apparatus according to claim 5, wherein the computer-readable code when executed controls the at least one processor to respond to received selection of the first alphabet character by causing display of the alphabet character such that it is smaller than the diacritical character displayed in the same region.

7. Apparatus according to claim 29, further comprising a touch-sensitive display and wherein the first and subsequent user selections are receivable through the touch-sensitive display.

8. Apparatus according to claim 29, wherein the computer-readable code when executed controls the at least one processor to provide a text editor into which either the first character or the modified first character is entered following subsequent selection.

9. Apparatus according to claim 29, wherein the computer-readable code when executed controls the at least one processor to cause re-display of the first keyboard, following the subsequent selection.

10. Apparatus according to claim 29, wherein the first and second keyboards comprise substantially identical selectable-region layouts.

11. Apparatus according to claim 29, wherein the computer-readable code when executed controls the at least one processor to configure the dual-character regions such that the alphabetic character is displayed with a predetermined diacritical character in accordance with the Vietnamese telex standard/protocol.

12. Apparatus according to claim 29, wherein the apparatus is a mobile communications terminal.

13. (canceled)

14. A method comprising:
displaying on a user interface a first keyboard comprising individually-selectable regions each displaying a different alphabet character;
receiving user-selection of a first alphabet character for entry into a text string through a region of the keyboard;
in response to selection of the first alphabet character, causing display of a second keyboard including a plurality of dual-character regions each including a different alphabet character and a different diacritical character appropriate to the selected first alphabet character;
receiving a subsequent user selection of one of the dual-character regions; and
dependent on one or more attributes of the subsequent user selection, performing one of (i) replacing the first alphabet character in the text string with a diacriticized version of said character determined by the selected dual-character region, and (ii) entering into the text string of a further, second alphabetic character, being that shown on the selected dual-character region.

15. A method according to claim 14, comprising performing one of (i) and (ii) dependent on attributes of a single user input made in relation to the dual-character region.

16. A method according to claim 15, comprising performing one of (i) and (ii) dependent on the duration of the single user input made in relation to the dual-character region.

17. (canceled)

18. (canceled)

19. (canceled)

20. (canceled)

21. (canceled)

22. (canceled)

23. (canceled)

24. (canceled)

25. A method according to claim 14, performed on a communications terminal.

26. A method comprising:
displaying on a user interface a keyboard comprising a plurality of individually-selectable keys each displaying a different alphabet character;
receiving user selection of a first alphabet character;
in response to said user selection, modifying a subset of the keys such that each one of said modified keys is shown with its original alphabet character and a respective one of a set of different diacritical characters appropriate to the selected first alphabet character; and
receiving user selection through one of the modified keys of either the selected alphabet character or a modified version of the first alphabet character having the diacritical mark shown on the selected modified key.

27. (canceled)

28. A non-transitory computer-readable storage medium having stored thereon computer-readable code, which, when executed by computing apparatus, causes the computing apparatus to perform a method comprising:
displaying on a user interface a first keyboard comprising individually-selectable regions each displaying a different alphabet character;
receiving user-selection of a first alphabet character for entry into a text string through a region of the keyboard;
in response to selection of the first alphabet character, causing display of a second keyboard including a plurality of dual-character regions each including a different alphabet character and a different diacritical character appropriate to the selected first alphabet character;
receiving a subsequent user selection of one of the dual-character regions; and
dependent on one or more attributes of the subsequent user selection, performing one of (i) replacing the first alphabet character in the text string with a diacriticized version of said character determined by the selected dual-character region, and (ii) entering into the text string of a further, second alphabetic character, being that shown on the selected dual-character region.

29. Apparatus, the apparatus having at least one processor and at least one memory having computer-readable code stored thereon which when executed controls the at least one processor:
to cause display on a user interface of a first keyboard comprising individually-selectable regions each displaying a different alphabet character;
to receive user-selection of a first alphabet character for entry into a text string through a region of the keyboard;
in response to received selection of the first alphabet character to cause display of a second keyboard including a plurality of dual-character regions each including a different alphabet character and a different diacritical character appropriate to the selected first alphabet character; and
in response to subsequent user selection of one of the dual-character regions, and dependent on one or more attributes of the subsequent user selection, to perform one of (i) replacing the first alphabet character in the text string with a diacriticized version of said character determined by the selected dual-character region, and (ii) entering into the text string of a further, second alphabetic character, being that shown on the selected dual-character region.

30. Apparatus, the apparatus having at least one processor and at least one memory having computer-readable code stored thereon which when executed controls the at least one processor:
to cause display on a user interface of a keyboard comprising a plurality of individually-selectable keys each displaying a different alphabet character;
to receive user selection of a first alphabet character;
to respond to said user selection to modify a subset of the keys such that each one of said modified keys is shown with its original alphabet character and a respective one of a set of different diacritical marks appropriate to the selected first alphabet character; and
to receive user selection through one of the modified keys of one of a further alphabet character or a modified version of the first alphabet character having the diacritical mark shown on the selected modified key.

31. A non-transitory computer-readable storage medium having stored thereon computer-readable code, which, when executed by computing apparatus, causes the computing apparatus to perform a method comprising:
displaying on a user interface a keyboard comprising a plurality of individually-selectable keys each displaying a different alphabet character;
receiving user selection of a first alphabet character;
in response to said user selection, modifying a subset of the keys such that each one of said modified keys is shown with its original alphabet character and a respective one of a set of different diacritical characters appropriate to the selected first alphabet character; and
receiving user selection through one of the modified keys of either the selected alphabet character or a modified version of the first alphabet character having the diacritical mark shown on the selected modified key.
